(19) United States
(12) Patent Application Publication
(10) Pub. No.: US 2026/0339629 A1
(43) Pub. Date: Oct. 29, 2026

(54) METHODS AND APPARATUS FOR OPTIMIZING CODE FOR HETEROGENEOUS CPU SYSTEMS

(71) Applicant: HUAWEI TECHNOLOGIES CO., LTD., Shenzhen (CN)

(72) Inventors: Henry Fangli Kao, Toronto (CA); Prabhdeep Singh Soni, Toronto (CA); Bryan Pak Kwai Chan, Markham (CA); Reza Azimi, Toronto (CA); Maziar Goudarzi, Toronto (CA)

(73) Assignee: HUAWEI TECHNOLOGIES CO., LTD., Shenzhen (CN)

(21) Appl. No.: 19/187,755

(22) Filed: Apr. 23, 2025

(51) Int. Cl. G06F 8/41

(52) U.S. Cl. CPC G06F 8/41

(57) ABSTRACT

There is provided a method for compiling code for heterogeneous systems. A heterogeneous system may comprise a plurality of microarchitectures, and some code segments may have greater affinity to some microarchitectures over others. The method involves providing microarchitecture affinity information for code segments of the source code, and compiling different code segments for different microarchitectures based on the received microarchitecture affinity information.

### CROSS-REFERENCE TO RELATED APPLICATIONS

The present application is the first application for this disclosure.

### FIELD OF THE DISCLOSURE

The present disclosure relates to compilers. Specifically, the present disclosure provides a method for compiling code in a manner that is optimized for heterogeneous Central Processing Unit (CPU) systems.

### BACKGROUND

Heterogeneous CPU systems contain multiple CPUs of different microarchitectures. Programs running on heterogeneous CPU systems are dynamically scheduled across the different cores. A single program may run on any CPU at any given time, thus the instruction set and instruction set features (e.g., vector extensions, cryptography extensions, etc.) should be consistent across all CPUs. The difference in microarchitecture between CPUs may take the form of in-order execution versus out-of-order execution, and differences in the memory cache sizes and cache hierarchy.

### SUMMARY

It is an object of the present disclosure to provide an improved method for compiling code for heterogeneous CPU systems.

According to a first aspect, there is provided a method at a computing device for compiling code for a heterogeneous system, comprising receiving translation units to compile, the translation units comprising a plurality of code segments, receiving affinity information for at least one code segment of the plurality of code segments, the affinity information indicating a microarchitecture, marking the at least one code segment with the microarchitecture, and compiling the at least one code segment for the microarchitecture.

According to an embodiment of the first aspect, the method further comprises receiving second affinity information for a second code segment of the plurality of code segments, the second affinity information indicating a second microarchitecture, marking the second code segment with the second microarchitecture, and compiling the second code segment for the second microarchitecture.

According to another embodiment of the first aspect, the method further comprises compiling unmarked code segments for a default microarchitecture.

According to yet another embodiment of the first aspect, the affinity information comprises a level of affinity.

According to yet another embodiment of the first aspect, the method further comprises when the level of affinity is less than a threshold, marking the at least one code segment with a default microarchitecture, and compiling the at least one code segment for the default microarchitecture.

According to yet another embodiment of the first aspect, the affinity information is provided as a separate file, the separate file identifying the at least one code segment by file name and line numbers.

According to yet another embodiment of the first aspect, said compiling the at least one code segment for the microarchitecture comprises using optimization techniques which are specific to the microarchitecture.

According to yet another embodiment of the first aspect, the at least one code segment is one of a basic block, a function, or a function call-chain.

According to a second aspect, there is provided a computing device for compiling code for a heterogeneous system, comprising a processor and memory, the computing device being configured to receive translation units to compile, the translation units comprising a plurality of code segments, receive affinity information for at least one code segment of the plurality of code segments, the affinity information indicating a microarchitecture, mark the at least one code segment with the microarchitecture, and compile the at least one code segment for the microarchitecture.

According to an embodiment of the second aspect, the computing device is further configured to receive second affinity information for a second code segment of the plurality of code segments, the second affinity information indicating a second microarchitecture, mark the second code segment with the second microarchitecture, and compile the second code segment for the second microarchitecture.

According to another embodiment of the second aspect, the computing device is further configured to compile unmarked code segments for a default microarchitecture.

According to yet another embodiment of the second aspect, the affinity information comprises a level of affinity.

According to yet another embodiment of the second aspect, the computing device is further configured to when the level of affinity is less than a threshold, mark the at least one code segment with a default microarchitecture, and compile the at least one code segment for the default microarchitecture.

According to yet another embodiment of the second aspect, the affinity information is provided as a separate file, the separate file identifying the at least one code segment by file name and line numbers.

According to yet another embodiment of the second aspect, said compiling the at least one code segment for the microarchitecture comprises using optimization techniques which are specific to the microarchitecture.

According to yet another embodiment of the second aspect, the at least one code segment is one of a basic block, a function, or a function call-chain.

According to a third aspect, there is provided a computer readable medium having stored thereon executable code for execution by a processor of a computing device, the executable code comprising instructions for receiving translation units to compile, the translation units comprising a plurality of code segments, receiving affinity information for at least one code segment of the plurality of code segments, the affinity information indicating a microarchitecture, marking the at least one code segment with the microarchitecture, and compiling the at least one code segment for the microarchitecture.

### BRIEF DESCRIPTION OF THE DRAWINGS

FIG. 1 is a block diagram of a heterogeneous CPU system according to at least some embodiments of the present disclosure.

FIG. 2 is a block diagram illustrating how different code segments may be scheduled to run on different microarchitectures, according to at least some embodiments of the present disclosure.

FIG. 3 is a block diagram illustrating code segment indicators according to at least some embodiments of the present disclosure.

FIG. 4A is a block diagram of a conventional method for compiling code into an executable.

FIG. 4B is a block diagram of a method for compiling code into an executable according to at least some embodiments of the present disclosure.

FIG. 5 illustrates various code segments which may be mapped to different microarchitectures according to at least some embodiments of the present disclosure.

FIG. 6 is a flow diagram of a method according to at least some embodiments of the present disclosure.

FIG. 7 is a block diagram of a computing device according to at least some embodiments of the present disclosure.

### DETAILED DESCRIPTION

The present disclosure provides an improved method for compiling code for heterogeneous CPU systems.

For the purposes of the present disclosure, the following definitions shall apply.

Compiler: a computer program that transforms code written in one language (source language) into another language (target language). Often the target language is machine code that is executable on the target machine. The compiler may also apply optimization techniques to the code to improve performance.

Translation Unit: an input file for the compiler containing code written in the source language.

Instruction Set: a definition of a set of instructions, data types and registers a CPU is able to process. A program must be compiled to use the instructions, data types and registers defined in the instruction set to be able to run properly on the CPU.

Microarchitecture: the hardware in a CPU used to implement an instruction set. There can be multiple ways to implement the same instruction set using different microarchitectures.

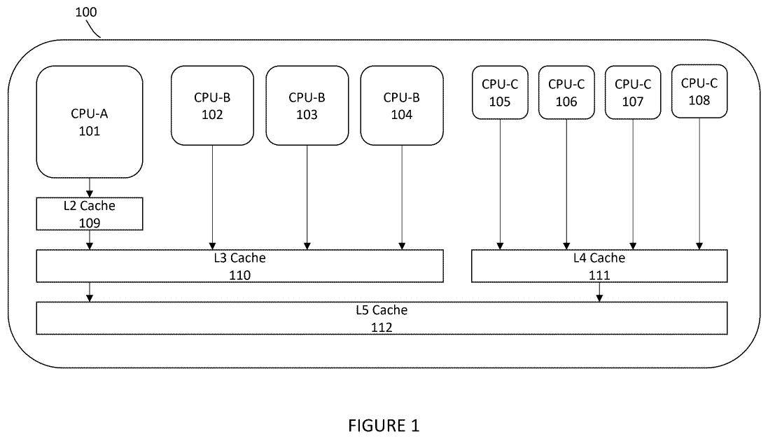

FIG. 1 illustrates a heterogeneous CPU system according to at least some embodiments of the present disclosure. The system shown in FIG. 1 is intended for illustrative purposes only, and is not intended to be limiting.

As seen in FIG. 1, a heterogeneous CPU system 100 comprises a first CPU 101 having a first microarchitecture, three CPUs 102, 103, and 104 having a second microarchitecture, and four CPUs 105, 106, 107, and 108, having a third microarchitecture. Each of the first, second, and third microarchitecture may be different from each other, but implement the same instruction set. Differences in microarchitectures may include, but not limited to differences in the execution paradigm (e.g., in-order versus out-of-order), differences in speculative execution hardware (i.e., branch prediction), and differences in instruction latency and throughput. As also illustrated in FIG. 1, the cache memory hierarchy may also be different between the different CPU types. For example, CPU 101 uses cache L2 109, cache L3 110, and cache L5 112, CPUs 102, 103, and 104 use cache L3 110, and cache L5 112, whereas CPUs 105, 106, 107, and 108 use cache L4 111, and cache L5 112.

When compiling code, different performance optimizations techniques may be used. However, these optimization techniques may perform differently on different microarchitectures, even though the different microarchitectures may share an instruction set and instruction set features.

Conventionally, compilers may apply performance optimizations techniques that are specifically targeted for a specific microarchitecture. This works well in cases of a single CPU system, or in a multi-CPU system where all CPUs have the same microarchitecture. However, the CPUs in heterogeneous systems have different microarchitectures, and applying performance optimizations to code tailored for one microarchitecture could have adverse performance effects if the code is scheduled on a CPU of a different microarchitecture.

Known techniques for optimizing code for heterogeneous systems include fat binaries, and function multi-versioning.

Fat binaries are executable programs or libraries enlarged to contain code for multiple instruction sets, and which can be run on different processor types. Function multi-versioning is a technique in which different implementations of the same function, each specifically optimized for different instruction set features, are included in a program. The compiler inserts some logic into the code for selecting the correct version of the function to execute at runtime based on which instruction feature the CPU supports.

However, fat binaries are intended to be a single binary that is able to run on different instruction sets (e.g., x86 and ARM). Heterogeneous CPU systems generally have the same instruction set running on all CPUs. Accordingly, a fat binary with code native to different instruction sets does not solve the problem of code not being optimized for different microarchitectures.

Similarly, function multi-versioning is used to target different instruction set features depending on what the CPU supports. CPUs in a heterogeneous system typically share the same instruction set features, and therefore, a program using function multi-versioning will always choose the same version of the function when running on a typical heterogeneous system. Accordingly, function multi-versioning does not address optimization of code for different microarchitectures running the same instruction set features.

The present disclosure provides a method by a compiler to optimize code for multiple microarchitectures present in a heterogeneous CPU system. The method may comprise segmenting a large code base within a translation unit into small segments, and using prior knowledge or measurements to determine if a given code segment is better suited for running on one type of microarchitecture over another. When a code segment is found to be better suited to one microarchitecture, the compiler optimizes the code segment to target this one microarchitecture. According to at least some embodiments, the compiler may optimize a single translation unit for multiple different microarchitectures.

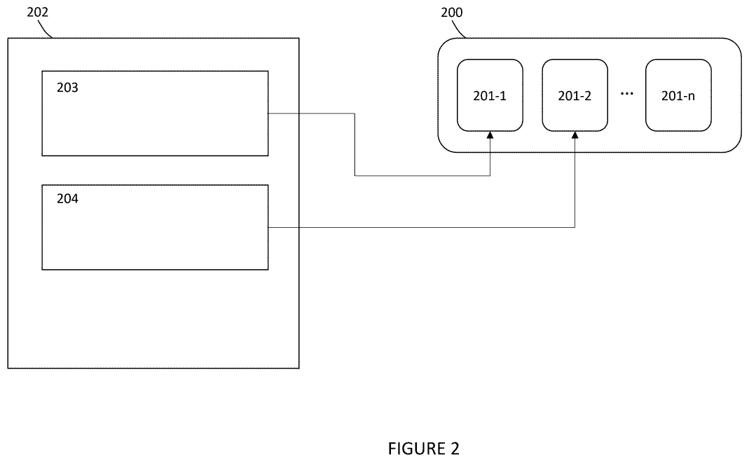

Conventional compilers optimize an entire translation unit to target one CPU microarchitecture. However, different segments of executable code from the same translation unit may be scheduled to execute on different CPUs with a different microarchitecture within a heterogeneous CPU system, as shown in FIG. 2.

Specifically, as seen in FIG. 2, a translation unit 202 may comprise code segment 203 and code segment 204, for running on heterogeneous system 200, comprising CPUs 201-1, 201-2, . . . , and 201-n, where each CPU may have a different microarchitecture. Code segment 203 may be best suited for running on CPU 201-1, and code segment 204 may be best suited for running on CPU 201-2, which has a different microarchitecture than CPU 201-1

Applying code optimization techniques to an entire translation unit targeting one microarchitecture present in heterogeneous system 200 may only be beneficial for code segment 203, and other code segments that are best suited for the microarchitecture of CPU 201-1, but not for code segment 204 and other similar code segments. Accordingly, different code segments in the same translation unit may suffer from adverse performance effects from being scheduled and executed on a CPU having a microarchitecture for which the code segment was not optimized.

Generally, different code segments within the same translation unit may exhibit differing levels of affinity to different CPUs in a heterogeneous system. In the present context, affinity is defined as a code segment's propensity to run more efficiently on a given microarchitecture over other microarchitectures present in the same heterogeneous system. This may occur due to application developer behavior, operating system or kernel behavior, and other factors.

According to at least some embodiments of the present disclosure, information about the affinity of a code segment to a CPU microarchitecture is provided as an input to the compiler. This information may be obtained through common code profiling methods (i.e., sample profiling) known to those skilled in the art. Regions of code in the same translation unit (e.g., on the level of functions) may be marked with a microarchitecture indicator, to indicate to the compiler what microarchitecture it should be optimized for.

According to at least some embodiments of the present disclosure, affinity information is related to a code segment. A code segment may be identified using a filename and line numbers, or a function name, or using compiler directives, amongst other solutions. The affinity information further indicates a microarchitecture which is included in the heterogeneous system for which the program is being compiled. According to at least some embodiments, the affinity information may further comprise a level of affinity, which may be expressed as a numerical value, or a label.

For example, the level of affinity may be expressed as a value between 0 and 10. Alternatively, the level of affinity may be expressed as a label such as “excellent”, “good”, “average”, “poor”, amongst others.

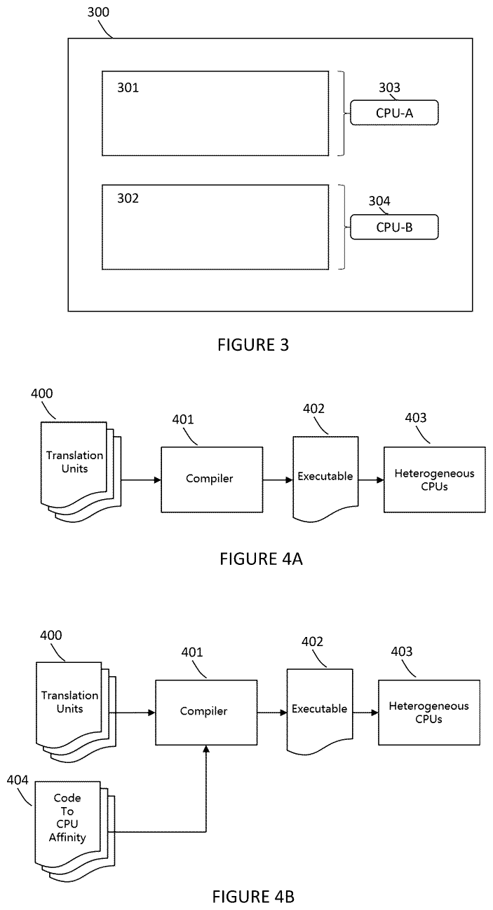

As seen in FIG. 3, a translation unit 300 may comprise code segments 301 and 302. Code segments 301 and 302 each have a microarchitecture indicator associated therewith, namely indicators 303 and 304, respectively. Indicators 303 and 304 indicate to the compiler which microarchitecture to optimize the code for, and correspond to microarchitectures which are present in the heterogeneous system for which the code is being compiled. In the example of FIG. 3, code segment 301 will be optimized for microarchitecture CPU-A, and code segment 302 will be optimized for microarchitecture CPU-B.

Reference is now made to FIG. 4A, which shows a conventional compiler procedure for compiling code into an executable for execution on a heterogeneous system. Specifically, as seen in FIG. 4A, translation units 400 are input to the compiler or program optimizer 401 which applies various code optimization for the specified target hardware to generate an executable 402. The executable 402 is in the form of machine code which is able to run on the target hardware, in this case a heterogeneous CPU system 403.

Reference is now made to FIG. 4B, which shows a compiler procedure according to at least some embodiments of the present disclosure. Specifically, as does FIG. 4A, FIG. 4B shows translation units 400, which are input to the compiler 401, to generate executable 402. However, unlike the procedure illustrated in FIG. 4A, the procedure illustrated in FIG. 4B further comprises additional inputs 404 associated to at least one code segment of translation units 400, indicating microarchitecture affinity input. The information provided in the code to microarchitecture affinity input 404 maps a segment of code to the microarchitecture it should be optimized for. The microarchitecture indicated by microarchitecture affinity input 404 corresponds to a microarchitecture which is present in the heterogeneous system for which the code is being compiled.

According to at least some embodiment, the code to microarchitecture affinity input may take the form of a table, or a text file, in which code segments are mapped to microarchitectures. For example, code segments may be identified by addresses, where addresses may take the form of a filename and line number, as illustrated in the table below.

| Start Address | End Address | Microarchitecture |
|---|---|---|
| Program.c, line 50 | Program.c, line 75 | A |
| Library.c, line 30 | Library.c, line 200 | B |
| Library.c, line 250 | Library.c, line 320 | C |

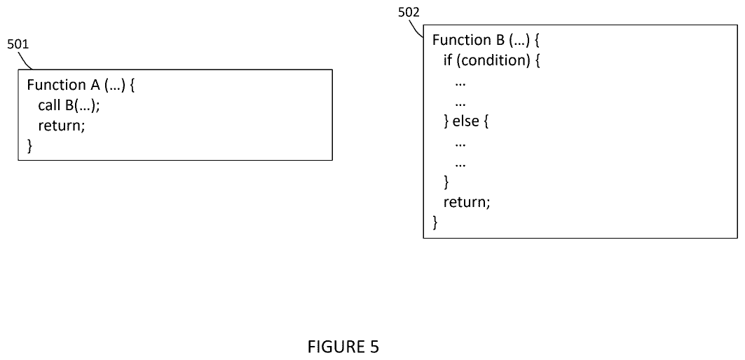

Code segments can take the form of, but not limited to, basic blocks, functions, function call-chains, amongst others. Basic blocks correspond to a granularity of code in which the technique can be applied, such as a straight line sequence of instruction with no branching. A function may contain multiple basic blocks. Function call chains may contain multiple functions related by how they call each other, as illustrated in FIG. 5.

Specifically, as seen in FIG. 5, a first function A 501 is shown, and function A makes a call to function B 502. Optimizing the function call chain for a given microarchitecture in this case would involve optimizing both functions A 501 and function B 502 together.

Furthermore, as illustrated in FIG. 5, function B 502 comprises an if-else statement, in which one basic block is executed when a condition is true, and a different basic block is executed when the same condition is false. Each of these basic blocks may be optimized for the same, or different microarchitectures.

According to at least some embodiments, the microarchitecture affinity input 404 may be provided in line with the code. For example, the microarchitecture affinity input 404 may be provided as C++ preprocessor directives, or the like.

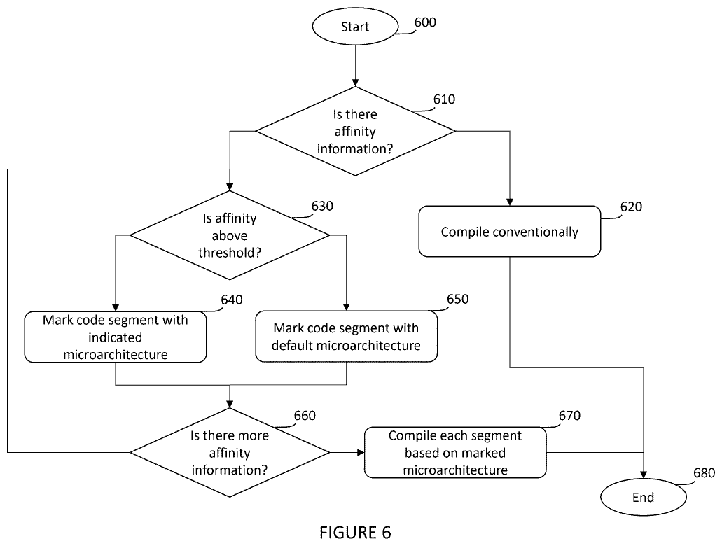

Reference is now made to FIG. 6, which illustrates a method for compiling code according to at least some embodiments of the present disclosure.

As seen in FIG. 6, the method starts at block 600 and proceeds to block 610 where it is determined whether any microarchitecture affinity information is provided. If no microarchitecture affinity information is provided, the method proceeds to block 620 and conventional compilation of the code is performed. The method then ends at block 680.

If at block 610 it is determined that some microarchitecture affinity information is provided, the method proceeds to block 630, to check if the affinity for a portion of code is above a threshold. If the affinity is above the threshold, the method proceeds to block 640 to mark the code segment to be compiled for the indicated microarchitecture. If the affinity is less than the threshold, the method proceeds to block 650 to mark the code segment to be compiled for a default architecture.

In at least some embodiments, the threshold may be settable (or configurable) by the user.

Notably, blocks 630, 640, and 650, are optional, and in some embodiments no threshold is used, and each code segment is marked to be compiled with the indicated microarchitecture when such an indication exists.

The method then proceeds to block 660, to check if there is more affinity information to process. If yes, the method returns to block 630 to check if the affinity is above the threshold, and if no, the method proceeds to block 670 to compile each code segment according to the indicated architecture. As will be appreciated, code segments for which no microarchitecture is indicated may be compiled for a default microarchitecture.

The method then ends at block 680.

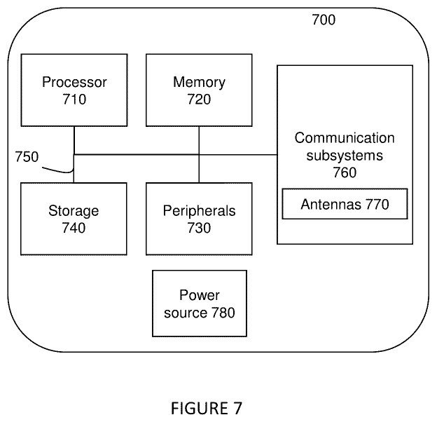

The above functionality may be implemented on any one or combination of computing devices. FIG. 7 is a block diagram of a computing device 700 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 700 may comprise a processor 710, memory 720, a mass storage device 740, and peripherals 730. Peripherals 730 may comprise, amongst others one or more input/output devices, such as a speaker, microphone, mouse, touchscreen, keypad, keyboard, printer, display, network interfaces, and the like. Communications between processor 710, memory 720, mass storage device 740, and peripherals 730 may occur through one or more buses 750.

The bus 750 may be one or more of any type of several bus architectures including a memory bus or memory controller, a peripheral bus, video bus, or the like. The processor 710 may comprise any type of electronic data processor. The memory 720 may comprise any type of system memory such as static random-access memory (SRAM), dynamic random-access memory (DRAM), synchronous DRAM (SDRAM), read-only memory (ROM), a combination thereof, or the like. In an embodiment, the memory 720 may include ROM for use at boot-up, and DRAM for program and data storage for use while executing programs.

The mass storage device 740 may comprise any type of storage device configured to store data, programs (e.g. instructions or code), and other information and to make the data, programs, and other information accessible via the bus. The mass storage device 740 may comprise, for example, one or more of a solid-state drive, hard disk drive, a magnetic disk drive, an optical disk drive, or the like. The memory 720 or mass storage 740 may store instructions, which when executed by a processor or processing unit, cause or configure the computing device 700 to perform any of the methods described herein.

Computing device 700 may further comprise a communications subsystem 760 for communicating with other computing devices or for connecting computing device 700 to a computer network. Communications subsystem 760 may comprise one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas 770 and one or more receivers/receive antennas 770. In an embodiment, the processing unit is coupled to a local-area network or a wide-area network, for data processing and communications with remote devices, such as other processing units, the Internet, remote storage facilities, or the like.

Computing device may further comprise a power source 780.

The present disclosure may be implemented on a computing device such as exemplary computing device 700. Computing device 700 may be a network element of a telecommunications network, such that the network element may be connected to other network elements of the telecommunication network, where all network elements form the telecommunication network. The network element may also receive communications from client devices connected to the telecommunication network and provide services to such client devices.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method at a computing device for compiling code for a heterogeneous system, the heterogeneous system comprising a plurality of microarchitectures distinct from each other, comprising:
receiving translation units to compile, the translation units comprising a plurality of code segments;
receiving affinity information for at least one code segment of the plurality of code segments, the affinity information indicating a microarchitecture amongst the plurality of microarchitectures;
marking the at least one code segment with the microarchitecture; and
compiling the at least one code segment for the microarchitecture.

2. The method of claim 1, further comprising:
receiving second affinity information for a second code segment of the plurality of code segments, the second affinity information indicating a second microarchitecture amongst the plurality of microarchitectures;
marking the second code segment with the second microarchitecture; and
compiling the second code segment for the second microarchitecture.

3. The method of claim 1, further comprising:
compiling unmarked code segments for a default microarchitecture.

4. The method of claim 1, wherein the affinity information comprises a level of affinity.

5. The method of claim 4, further comprising:
when the level of affinity is less than a threshold, marking the at least one code segment with a default microarchitecture; and
compiling the at least one code segment for the default microarchitecture.

6. The method of claim 1, wherein the affinity information is provided as a separate file, the separate file identifying the at least one code segment by file name and line numbers.

7. The method of claim 1, wherein said compiling the at least one code segment for the microarchitecture comprises using optimization techniques which are specific to the microarchitecture.

8. The method of claim 1, wherein the at least one code segment is one of a basic block, a function, or a function call-chain.

9. A computing device for compiling code for a heterogeneous system, comprising:
at least one processor; and
memory storing executable code for execution by the at least one processor, the executable code comprising instructions configuring the computing device to:
receive translation units to compile, the translation units comprising a plurality of code segments;
receive affinity information for at least one code segment of the plurality of code segments, the affinity information indicating a microarchitecture;
mark the at least one code segment with the microarchitecture; and
compile the at least one code segment for the microarchitecture.

10. The computing device of claim 10, the instructions further configuring the computing device to:
receive second affinity information for a second code segment of the plurality of code segments, the second affinity information indicating a second microarchitecture;
mark the second code segment with the second microarchitecture; and
compile the second code segment for the second microarchitecture.

11. The computing device of claim 10, the instructions further configuring the computing device to:
compile unmarked code segments for a default microarchitecture.

12. The computing device of claim 10, wherein the affinity information comprises a level of affinity.

13. The computing device of claim 12, the instructions further configuring the computing device to:
when the level of affinity is less than a threshold, mark the at least one code segment with a default microarchitecture; and
compile the at least one code segment for the default microarchitecture.

14. The computing device of claim 10, wherein the affinity information is provided as a separate file, the separate file identifying the at least one code segment by file name and line numbers.

15. The computing device of claim 10, wherein said compiling the at least one code segment for the microarchitecture comprises using optimization techniques which are specific to the microarchitecture.

16. The computing device of claim 10, wherein the at least one code segment is one of a basic block, a function, or a function call-chain.

17. A computer readable medium having stored thereon executable code for execution by a processor of a computing device, the executable code comprising instructions for:
receiving translation units to compile, the translation units comprising a plurality of code segments;
receiving affinity information for at least one code segment of the plurality of code segments, the affinity information indicating a microarchitecture;
marking the at least one code segment with the microarchitecture; and
compiling the at least one code segment for the microarchitecture.
